(19) United States
(12) Patent Application Publication
(10) Pub. No.: US 2022/0316616 A1
(43) Pub. Date: Oct. 6, 2022

(54) VALVE BODY STRUCTURE

(71) Applicant: AQUIVIO CO., LTD., Taipei City (TW)

(72) Inventors: Daniel Hill, Taipei City (TW); Yi-Hsuan Chang, Taipei City (TW)

(21) Appl. No.: 17/706,571

(22) Filed: Mar. 28, 2022

(30) Foreign Application Priority Data
Mar. 30, 2021 (TW) 110203448

(51) Int. Cl. F16K 27/02; F17D 3/12; B01F 23/451; B01F 25/314; B01F 35/71

(52) U.S. Cl. CPC F16K 27/029; F17D 3/12; B01F 23/451; B01F 25/314; B01F 35/718051

(57) ABSTRACT

A valve body structure is provided and includes a main pipe, a secondary pipe and a liquid storage tank, where the liquid storage tank stores a second liquid from the secondary pipe and controls whether the second liquid in the liquid storage tank flows into the main pipe by a solenoid valve, so that the second liquid is mixed with a first liquid in the main pipe. Therefore, the valve body structure can mix liquids without combining other components and has a lower cost and a smaller volume. As such, the issue of the remaining residual liquid when combined with other components for control, which reduces the control accuracy and even causes the problem of mixed pollution, can be avoided.

### BACKGROUND

### 1. Technical Field

The present disclosure relates to a valve body structure, and more particularly, to a valve body structure for mixing liquids.

### 2. Description of Related Art

The general valve body is a single pipe, and the general valve body is actuated by a solenoid valve to switch the general valve body to control the flow of liquid in a pipe.

However, when a user needs to control the mixing of two liquids through the general valve body, at least one general valve body is combined with a Y-shaped three-way pipe to achieve this. For instance, the general valve body is connected to one pipeline of the Y-shaped three-way pipe to control whether the liquid in the pipeline is mixed with the liquid in other pipelines. However, this method must be combined with a Y-shaped three-way pipe, which not only increases the cost but also has a larger structure, so it is difficult to install on a small-volume device, and it is easy to have residual liquid in the Y-shaped three-way pipe. As a result, the control accuracy is reduced, and even mixed pollution problems occur.

Therefore, how to overcome the various problems of the general valve body so as to make the valve body lower in cost and smaller in size has become an urgent problem to be solved at present.

### SUMMARY

In view of the aforementioned drawbacks of the prior art, the present disclosure provides a valve body structure, which comprises: a main pipe including a main pipe body and a branch pipe body communicating with the main pipe body; a secondary pipe disposed on the main pipe body; and a liquid storage tank having a notch, wherein the notch is located on the main pipe to form an accommodating space, the secondary pipe communicates with the accommodating space, and the branch pipe body is located in the accommodating space.

In the aforementioned valve body structure, the main pipe body has a first liquid input port and a first liquid output port opposite to the first liquid input port.

In the aforementioned valve body structure, the first liquid input port has a pipe diameter greater than a pipe diameter of the first liquid output port.

In the aforementioned valve body structure, the branch pipe body has an opening, and the opening communicates with an interior of the main pipe body and the accommodating space.

In the aforementioned valve body structure, the liquid storage tank further includes at least one connecting hole for connecting a solenoid valve, wherein the solenoid valve covers the notch, and a plunger of the solenoid valve movably inserts into the opening of the branch pipe body.

In the aforementioned valve body structure, the secondary pipe includes a secondary pipe body having a second liquid input port.

In the aforementioned valve body structure, the secondary pipe body is obliquely disposed on the main pipe body, a second liquid output port is formed at a junction between the secondary pipe body and the main pipe body, and the second liquid output port communicates with the accommodating space.

In the aforementioned valve body structure, the secondary pipe and the branch pipe body are perpendicular to each other.

In the aforementioned valve body structure, the main pipe body further includes a fixing base disposed on an opposite side of the branch pipe body.

In the aforementioned valve body structure, the main pipe, the secondary pipe and the liquid storage tank are made of metal or plastic.

It can be seen from the above that the valve body structure of the present disclosure mainly stores the second liquid from the secondary pipe via the liquid storage tank, and causes the second liquid to flow into the main pipe via the actuation of the solenoid valve, thereby controlling the mixing of the second liquid in the liquid storage tank and the first liquid in the main pipe. Therefore, compared with the prior art, the valve body structure of the present disclosure can be controlled to mix the liquids without combining other components, so the cost is lower and the volume is smaller. In addition, it solves the problem of the residual liquid remaining in the pipeline when combined with other components (such as Y-shaped three-way pipes, pipelines, etc.) for control in the prior art, which reduces the control accuracy and even causes mixed pollution.

### BRIEF DESCRIPTION OF THE DRAWINGS

FIG. 1 a schematic front perspective view of the valve body structure of the present disclosure.

FIG. 2 is a schematic rear perspective view of the valve body structure of the present disclosure.

FIG. 3 is a schematic plan view of the valve body structure of the present disclosure.

FIG. 4 is a schematic cross-sectional view of the valve body structure of the present disclosure.

### DETAILED DESCRIPTIONS

The following describes the implementation of the present disclosure with embodiments. One skilled in the art can easily understand the other advantages and effects of the present disclosure from the content disclosed in this specification.

It should be understood that, the structures, ratios, sizes, and the like in the accompanying figures are used to illustrate the content disclosed in the present specification for one skilled in the art to read and understand, rather than to limit the conditions for practicing the present disclosure. Any modification of the structure, alteration of the ratio relationship, or adjustment of the size without affecting the possible effects and achievable proposes should still fall in the range compressed by the technical content disclosed in the present specification. Meanwhile, terms such as “upper,” “lower,” “a,” “an,” and the like used herein are merely used for clear explanation rather than limiting practical range by the present disclosure, and thus, the alteration or adjustment of relative relationship thereof without essentially altering the technical content should be considered in the practical scope of the present disclosure.

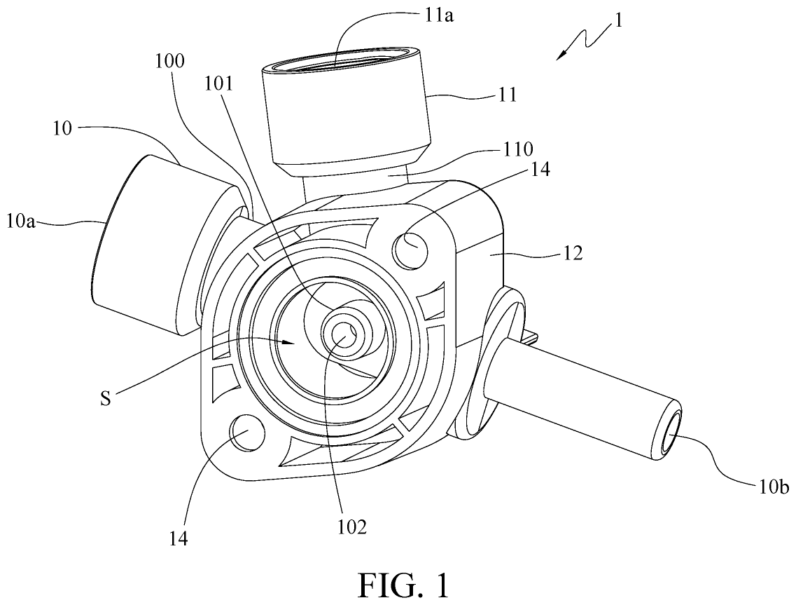

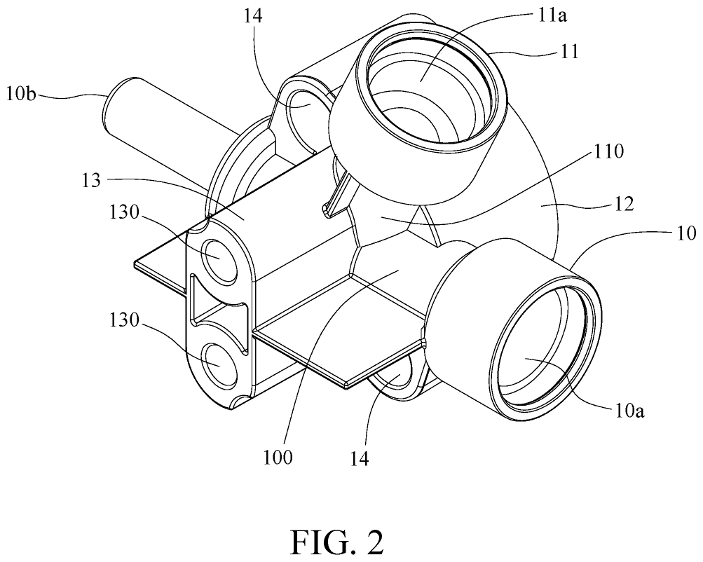

FIGS. 1 and 2 are schematic perspective views of a valve body structure 1 of the present disclosure. The valve body structure 1 includes: a main pipe 10, a secondary pipe 11 and a liquid storage tank 12.

The main pipe 10 includes a main pipe body 100 and a branch pipe body 101 arranged on the main pipe body 100.

In an embodiment, as shown in FIG. 1, the main pipe body 100 has a first liquid input port 10a and a first liquid output port 10b opposite to the first liquid input port 10a. The branch pipe body 101 has an opening 102, and the opening 102 of the branch pipe body 101 communicates with the interior of the main pipe body 100.

In one embodiment, the branch pipe body 101 is vertically arranged on the main pipe body 100, and the main pipe body 100 further includes a fixing base 13, which has at least one fixing hole 130, arranged on the opposite side of the branch pipe body 101 for the valve body structure 1 to be locked and fixed on a target.

In one embodiment, the material of the main pipe 10 includes metal, such as copper, stainless steel, etc., and plastic, such as polyethylene terephthalate (PET), polypropylene (PP), polystyrene (PS), etc., but not limited to the above.

In one embodiment, the main pipe body 100 has threads (not shown) on the inner pipe wall or the outer pipe body at the first liquid input port 10a and the first liquid output port 10b, so that external pipelines are joined with the main pipe body 100 via the threads of the inner pipe wall or the outer pipe body. Alternatively, the inner pipe wall or the outer pipe body is free from having threads, so that the external pipelines can be sleeved on the outer pipe body or penetrated into the inner pipe wall, thereby joining the main pipe body 100.

In one embodiment, the first liquid input port 10a and the first liquid output port 10b of the main pipe body 100 can also be connected to an external pipeline via ultrasonic welding technology. Alternatively, the main pipe body 100 and the external pipeline can be connected via a general quick connector. In addition, in another embodiment, a plurality of the valve body structures 1 can also be connected in series with each other. For example, the first liquid output port 10b of the valve body structure 1 is directly connected to the first liquid input port 10a of another valve body structure (not shown) by using ultrasonic welding technology, a quick connector or other joints, Therefore, the plurality of valve body structures 1 can be directly connected in series with each other without external pipelines.

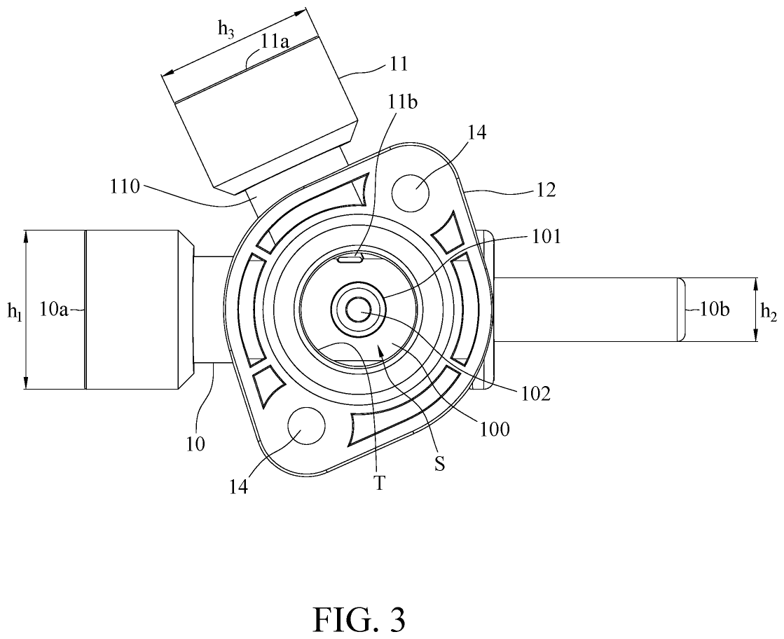

In one embodiment, as shown in FIG. 3, a pipe diameter h1 of the first liquid input port 10a and a pipe diameter h2 of the first liquid output port 10b can be adjusted according to requirements. In an embodiment, the pipe diameter h1 of the first liquid input port 10a is greater than the pipe diameter h2 of the first liquid output port 10b, wherein the pipe diameters h1, h2 include ¼ inches or ⅜ inches, but not limited to the above. It should be understood that the pipe diameters h1, h2 of the first liquid input port 10a and the first liquid output port 10b are ¼ inches or ⅜ inches, which is a common pipeline diameter specification, so it can be used directly with general pipelines and/or quick connectors.

The secondary pipe 11 includes a secondary pipe body 110 and is arranged on the main pipe body 100 of the main pipe 10.

In an embodiment, the secondary pipe body 110 has a second liquid input port 11a and is obliquely arranged on the main pipe body 100 of the main pipe 10. Furthermore, a second liquid output port 11b is formed at the junction between the secondary pipe body 110 and the main pipe body 100, so that the second liquid input port 11a communicates with the second liquid output port 11b, but the secondary pipe body 110 is free from communicating with the main pipe body 100.

In one embodiment, the direction of the second liquid input port 11a of the secondary pipe body 110 and the direction of the opening 102 of the branch pipe body 101 are perpendicular to each other, that is, the secondary pipe 11 (the secondary pipe body 110) and the branch pipe body 101 are perpendicular to each other.

In one embodiment, the material of the secondary pipe body 110 includes metal, such as copper, stainless steel, etc., and plastic, such as polyethylene terephthalate (PET), polypropylene (PP), polystyrene (PS), etc., but not limited to the above.

In one embodiment, the secondary pipe body 110 has threads on the inner pipe wall or the outer pipe body at the second liquid input port 11a, so that the external pipelines are joined with the secondary pipe body 110 via the threads of the inner pipe wall or the outer pipe body. Alternatively, the inner pipe wall or the outer pipe body is free from having threads (not shown), so that the external pipelines can be sleeved on the outer pipe body or penetrated into the inner pipe wall, thereby joining the secondary pipe body 110.

In one embodiment, the second liquid input port 11a of the secondary pipe body 110 can also be connected to an external pipeline via ultrasonic welding technology. Alternatively, the secondary pipe body 110 and the external pipeline can be connected via a general quick connector. In addition, the second liquid input port 11a of the valve body structure 1 can also be directly connected to the first liquid output port 10b of another valve body structure (not shown) by using ultrasonic welding technology, a quick connector or other joints, Therefore, the plurality of valve body structures 1 can be directly connected in series with each other without external pipelines.

In one embodiment, as shown in FIG. 3, a pipe diameter h3 of the second liquid input port 11a of the secondary pipe body 110 can be adjusted according to requirements, wherein the pipe diameter h3 includes ¼ inches or ⅜ inches, but not limited to the above. It should be understood that the pipe diameter h3 of the second liquid input port 11a is ¼ inches or ⅜ inches, which is a common pipeline diameter specification, so it can be used directly with general pipelines and/or quick connectors.

The liquid storage tank 12 includes a notch T and at least one connecting hole 14, and is arranged on the main pipe 10.

In an embodiment, as shown in FIG. 3, the notch T of the liquid storage tank 12 is arranged on the main pipe 10, and forms an accommodating space S with the main pipe body 100 of the main pipe 10, wherein the branch pipe body 101 of the main pipe 10 is located in the middle of the accommodating space S, and the second liquid output port 11b of the secondary pipe body 110 communicates with the accommodating space S.

In one embodiment, the material of the liquid storage tank 12 includes metal, such as copper, stainless steel, etc., and plastic, such as polyethylene terephthalate (PET), polypropylene (PP), polystyrene (PS), etc., but not limited to the above.

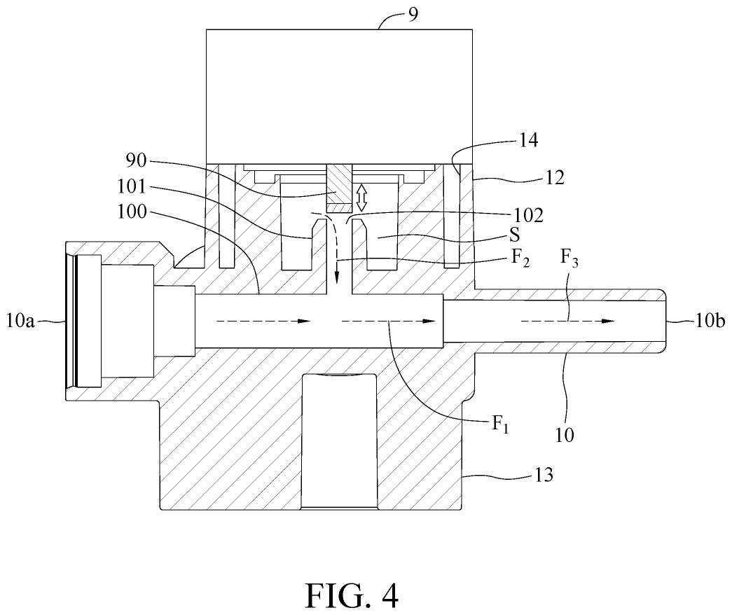

Please also refer to FIG. 4 in conjunction. In one embodiment, the connecting hole 14 is for a solenoid valve 9 to be connected onto the liquid storage tank 12, so that the solenoid valve 9 covers the notch T, such that the accommodating space S forms a closed space. In addition, a plunger 90 of the solenoid valve 9 is movably inserted into the opening 102 of the branch pipe body 101. In another embodiment, the solenoid valve 9 includes a direct-acting solenoid valve, a membrane solenoid valve, etc., but it is not limited to the above.

In one embodiment, the junction between the solenoid valve 9 and the liquid storage tank 12 is further provided with a waterproof rubber ring (not shown), and the waterproof rubber ring includes an O-ring to prevent the liquid in the accommodating space S of the liquid storage tank 12 from leaking out.

The following embodiments are actual operating embodiments of the valve body structure 1 of the present disclosure, and are described with reference to FIGS. 1 to 4 together.

In an embodiment, the solenoid valve 9 is arranged on the liquid storage tank 12 of the valve body structure 1, so that the accommodating space S of the liquid storage tank 12 forms a closed space, and the plunger 90 of the solenoid valve 9 is movably inserted into the branch pipe body 101 of the valve body structure 1.

For instance, the user injects a first liquid F1 and a second liquid F2 into the first liquid input port 10a of a main pipe 10 and the second liquid input port 11a of a secondary pipe 11 in the valve body structure 1, respectively. When the plunger 90 of the solenoid valve 9 penetrates the branch pipe body 101 of the main pipe 10, that is, when the plunger 90 plugs the opening 102 of the branch pipe body 101, the second liquid F2 is injected from the second liquid input port 11a, flows through the secondary pipe 11, flows out from the second liquid output port 11b of the secondary pipe 11, and fills the accommodating space S of the liquid storage tank 12. Furthermore, the first liquid F1 is injected from the first liquid input port 10a, flows through the main pipe 10, and flows out from the first liquid output port 10b of the main pipe 10.

Then, when the solenoid valve 9 is actuated to retract the plunger 90 into the solenoid valve 9, the plunger 90 is withdrawn from the opening 102 of the branch pipe body 101, so that the accommodating space S of the liquid storage tank 12 communicates with the main pipe 10, and the second liquid F2 flows into the main pipe 10 from the opening 102 of the branch pipe body 101 and then mixes with the first liquid F1. Finally, a third liquid F3 mixed by the first liquid F1 and the second liquid F2 flows out from the first liquid output port 10b.

In an embodiment, the first liquid F1 and the second liquid F2 are the same liquid or two different liquids, for example, water, beverage, tea, coffee, etc., but not limited to the above.

In summary, the valve body structure 1 of the present disclosure mainly stores the second liquid F2 from a secondary pipe 11 via a liquid storage tank 12, and controls whether the second liquid F2 in the liquid storage tank 12 flows into a main pipe 10 by a solenoid valve 9, thereby controlling the mixing of the second liquid F2 with the first liquid F1 in the main pipe 10. Therefore, compared with the prior art, the general valve body needs to be combined with other components (such as a Y-shaped three-way pipe) to achieve the effect of mixing two liquids, but the valve body structure 1 of the present disclosure may achieve the above-mentioned effects without needing to be combined with other components. Therefore, the cost is lowered and the volume is smaller, and the issue of the residual liquid remaining in the pipeline, which reduces the control accuracy and even causes the problem of mixed pollution, can be avoided.

Furthermore, by connecting the first liquid output port of the valve body structure to the first or second liquid input port of another valve body structure, the mixing of multiple liquids can be controlled. Moreover, compared with the prior art that requires external pipelines to connect different structures, the present disclosure can minimize or eliminate the residual mixed liquid remaining in the pipeline by directly connecting a plurality of valve body structures in series, and it can also minimize or eliminate pollution problems caused by the mixed liquids.

On the other hand, the present disclosure provides a more convenient way for mixing various liquids. Especially when applying the present disclosure to commercial or residential uses of beverages or water, it does not require the highest level of accuracy like industrial and medical valve bodies, so the present disclosure is more economical. For example, the variation of the present disclosure is allowed to be less than 0.1 ml, which is sufficient for the dispensing of beverages and water. In addition, the valve body structure of the present disclosure can also be replaced by higher-accuracy solenoid valve parts to improve the control accuracy, so that it can be used in industrial and medical applications.

The foregoing embodiments are used for the purpose of illustrating the principles and effects rather than limiting the present disclosure. Anyone skilled in the art can modify and alter the above embodiments without departing from the spirit and scope of the present disclosure. Therefore, the range claimed by the present disclosure should be as described by the accompanying claims listed below.

What is claimed is:

1. A valve body structure, comprising:
a main pipe including a main pipe body and a branch pipe body communicating with the main pipe body;
a secondary pipe disposed on the main pipe body; and
a liquid storage tank having a notch, wherein the notch is located on the main pipe to form an accommodating space, the secondary pipe communicates with the accommodating space, and the branch pipe body is located in the accommodating space.

2. The valve body structure of claim 1, wherein the main pipe body has a first liquid input port and a first liquid output port opposite to the first liquid input port.

3. The valve body structure of claim 2, wherein the first liquid input port has a pipe diameter greater than a pipe diameter of the first liquid output port.

4. The valve body structure of claim 1, wherein the branch pipe body has an opening, and the opening communicates with an interior of the main pipe body and the accommodating space.

5. The valve body structure of claim 4, wherein the liquid storage tank further includes at least one connecting hole for connecting a solenoid valve, wherein the solenoid valve covers the notch, and a plunger of the solenoid valve movably inserts into the opening of the branch pipe body.

6. The valve body structure of claim 1, wherein the secondary pipe includes a secondary pipe body having a second liquid input port.

7. The valve body structure of claim 6, wherein the secondary pipe body is obliquely disposed on the main pipe body, a second liquid output port is formed at a junction between the secondary pipe body and the main pipe body, and the second liquid output port communicates with the accommodating space.

8. The valve body structure of claim 1, wherein the secondary pipe and the branch pipe body are perpendicular to each other.

9. The valve body structure of claim 1, wherein the main pipe body further includes a fixing base disposed on an opposite side of the branch pipe body.

10. The valve body structure of claim 1, wherein the main pipe, the secondary pipe and the liquid storage tank are made of metal or plastic.
